(19) United States
(12) Patent Application Publication
(10) Pub. No.: US 2026/0241857 A1
(43) Pub. Date: Aug. 20, 2026

(54) Registration Plate Lighting Device for Illuminating a Registration Plate of a Motor Vehicle, Arrangement and Method

(71) Applicant: Bayerische Motoren Werke Aktiengesellschaft, Muenchen (DE)

(72) Inventors: Nicholas ALDERSLEY, Hebertshausen (DE); Matthias FINDEIS, Geltendorf (DE)

(21) Appl. No.: 18/876,832

(22) PCT Filed: May 30, 2023
(86) PCT No.: PCT/EP2023/064376

§ 371 Date: Dec. 19, 2024

(30) Foreign Application Priority Data
Jun. 28, 2022 (DE) 10 2022 116 059.9

(51) Int. Cl. B60Q 1/56; F21V 23/04; G01S 11/14

(52) U.S. Cl. CPC B60Q 1/56; F21V 23/0442; G01S 11/14

(57) ABSTRACT

A registration plate lighting device for illuminating a registration plate of a motor vehicle includes a housing element, which at least partially delimits a receiving space, at least one lighting element arranged in the receiving space for illuminating the registration plate, and at least one sensor element which is arranged in the receiving space and by which at least one acoustic signal from the surroundings of the motor vehicle can be detected.

### BACKGROUND AND SUMMARY

The invention relates to a registration plate illumination device for illuminating a registration plate of a motor vehicle. Moreover, the invention relates to an arrangement of a registration plate illumination device, which serves to illuminate a registration plate of a motor vehicle, on a component of the motor vehicle, and to a method for operating a motor vehicle comprising such a registration plate illumination device.

DE 10 2004 045 690 A1 has disclosed an apparatus for determining external sound sources in the surround of a motor vehicle, comprising a microphone array which is arranged on the motor vehicle and has a plurality of microphones for recording surround noises of a motor vehicle and comprising an evaluation device for evaluating the microphone signals.

The problem to be solved by the invention is that of developing a registration plate illumination device for illuminating a registration plate of a motor vehicle, an arrangement of a registration plate illumination device on a component of a motor vehicle and a method for operating a motor vehicle such that an installation space in the motor vehicle can be designed particularly advantageously.

According to the invention, this problem is solved by a registration plate illumination device for illuminating a registration plate of a motor vehicle, by an arrangement of a registration plate illumination device on a component of a motor vehicle, and by a method for operating a motor vehicle comprising a registration plate illumination device having the features of the independent claim(s). Advantageous configurations of the invention are the subject matter of the dependent claims and the description.

A first aspect of the invention relates to a registration plate illumination device for illuminating a registration plate of a motor vehicle. The motor vehicle is preferably embodied as motor-powered vehicle, in particular as an automobile, commercial vehicle or truck.

In particular, the registration plate can be understood to be an official identification of vehicles. In particular, the registration plate can be referred to as motor vehicle registration plate or license plate. For example, in the fully manufactured state of the motor vehicle, the registration plate is arranged in a rear region of the motor vehicle, in particular in or on the vehicle rear, on an outer side of the motor vehicle.

The registration plate illumination device comprises at least one housing element which at least partly delimits, more particularly completely delimits, an accommodation space. Expressed in other words, the accommodation space is surrounded by the housing element at least in part, in particular in full, or formed by the housing element. Hence the accommodation space is at least partly covered, more particularly completely covered, by the housing element. The accommodation space is part of the registration plate illumination device. This means that the registration plate illumination device comprises the accommodation space.

The registration plate illumination device comprises at least one illumination element which is arranged in the accommodation space and serves to illuminate the registration plate. Hence, the illumination element is arranged within the housing element. This means that the illumination device can be integrated into the housing element, the latter being able to be referred to as a housing in particular. Expressed in other words, the registration plate can be illuminated by means of the illumination element. For example, the illumination element comprises at least one light source. By preference, the illumination element, in particular the light source, is designed to emit or radiate light. The registration plate can be illuminated by the light radiated by means of the illumination element, in particular the light source. Hence, the illumination element, in particular the light source, can be understood in particular to be a lamp. For example, the illumination element is designed as a light-emitting diode (LED). By preference, a plurality of illumination elements provided for illuminating the registration plate, for example two illumination elements, are arranged in the accommodation space. For example, the illumination elements are designed as light-emitting diodes (LED).

For example, the registration plate illumination device should be held, in particular by way of the housing element, on an outer side of a bodyshell of the motor vehicle, in particular at least indirectly or directly on the bodyshell or on a component of the motor vehicle formed separately from the bodyshell. This means that the registration plate illumination device is arranged on or secured to the outer side of the bodyshell in the fully manufactured state of the motor vehicle. In this case, the registration plate illumination device can be held on or secured to the bodyshell, at least indirectly, in particular by way of the component. Hence, the registration plate illumination device is arranged or arrangeable outside of the bodyshell. The bodyshell can be understood to mean a structure of the motor vehicle in particular. By preference, the bodyshell is designed as a chassis, in particular a self-supporting chassis.

In order to be able to design an installation space of the motor vehicle particularly advantageously, in particular in order to be able to keep said installation space particularly small, the invention provides for at least one sensor element, in particular at least one acoustic sensor element, to be arranged in the accommodation space, the said sensor element rendering capturable or capturing at least one acoustic signal from a surround of the motor vehicle, especially when the registration plate illumination device is in the installed state in the motor vehicle. The sensor element is therefore arranged within the housing element. This means that the sensor element can be integrated into the housing element. Expressed in other words, the sensor element is at least partly surrounded, in particular fully surrounded, by the housing element. Expressed in yet other words, the sensor element is covered at least in part, in particular in full, by the housing element. The acoustic signal can be understood to mean a noise from a surround of the motor vehicle in particular. This means that an acoustic signal or noise emitted by a noise source situated in the surround of the motor vehicle is capturable by means of the sensor element. Hence, the acoustic signal can be transmitted by the noise source, in particular in the form of sound or soundwaves, and can be received or captured by the sensor element. The noise source can be understood to mean a sound source in particular. For example, the sensor element is designed as a microphone.

For example, at least one quantity that characterizes the acoustic signal is capturable by means of the sensor element. For example, the captured quantity is transmitted from the sensor element to an electronic computing device, wherein the acoustic signal can be ascertained or evaluated on the basis of the captured or transmitted quantity by means of the electronic computing device.

By preference, the noise source is a person, in particular a person situated in the surround of the motor vehicle. Hence, the acoustic signal can be noise emitted by the person, in particular caused by the person. By preference, the acoustic signal or noise is a voice, in particular a human voice, of the person. The voice, in particular a human voice, can be understood in particular to mean sound created by vocal folds in the larynx of the person and modulated in the vocal tract, especially oral cavity and/or pharyngeal cavity and/or nasal cavity, of the person. Consequently, the acoustic signal or the noise is a voice command, for example.

The invention is based on the following insights and considerations in particular: vehicles, especially motor vehicles, can be operated from the outside using mechanical and/or electrical elements. In this context, handles, pushbuttons, switches, radio remote controls or targeted movements of a person, for example, can be used for operating purposes. For example, a wing element, in particular a rear hatch, of the motor vehicle can be operated by way of haptic elements, for example pushbuttons, emblem actuation or the like. In an alternative to that or in addition, the wing element, in particular the rear hatch, can be operated by interior pushbuttons, a remote control or the targeted movement of the person. In particular, the targeted movement of the person can relate to a contactless operation, i.e. a contactless movement, within the scope of which the motor vehicle is not touched by the person. In this context, the targeted movement can be for example a movement of the foot of the person, referred to as a foot kick in particular. The operation or opening of the motor vehicle, in particular of the wing element, for example the rear hatch, can be referred to as a smart opener (SMO) in particular. In this case, the rear hatch can in particular be caused by a kicking movement of the foot or a rear bumper of the motor vehicle. Operation by the targeted movement in the form of a contactless operating site (smart opener) can be nonintuitive to the person and particularly susceptible to errors. This can have a negative effect on vehicle convenience. By contrast, using the registration plate illumination device according to the invention, which comprises at least one sensor element, allows the motor vehicle to be operated from the outside, i.e. from the surround, by way of voice operation or voice commands. This means that the vehicle can be controlled by the voice of the person in the surround. Hence, the wing element and/or a window of the motor vehicle, for example, can be opened and/or closed by the person using voice operation or a voice command. As a result, the motor vehicle can be controlled or operated from the outside with particularly little outlay, especially in a particularly intuitive manner. In particular, the wing element and/or the window can be opened or closed with particularly little outlay, especially in a particularly intuitive manner. This can particularly increase motor vehicle convenience.

As a result of the registration plate illumination device, in particular the sensor element, being arranged on the outer side of the bodyshell or motor vehicle, the acoustic signal for example can be captured particularly precisely and/or particularly reliably. Hence, the motor vehicle, in particular the wing element and/or the window, can be operated particularly reliably by the person. This can particularly increase motor vehicle convenience.

The installation space of the motor vehicle can be designed particularly advantageously, in particular kept particularly small, as a result of the sensor element being arranged in the registration plate illumination device or within the housing element or in the accommodation space. In this case, an existing installation space in the form of the registration plate illumination device or in the form of the accommodation space, which can be used to arrange the illumination element, for example can be additionally used to arrange the sensor element. Hence the sensor element can be housed in the motor vehicle in particularly installation-space-saving fashion. Expressed in other words, the sensor element can be attached to or housed in an existing exterior component on the motor vehicle in the form of the registration plate illumination device or the housing element. In particular, a dual function can be brought about by means of the registration plate illumination device, specifically the illumination of the registration plate by means of the illumination element and the capture of the acoustic signal from the surround of the motor vehicle by means of the sensor element. This means that a plurality of functions or tasks of the motor vehicle can be carried out by means of the registration plate illumination device. As a result, it is for example possible to manage without additional component parts or components of the motor vehicle. Hence, the weight of the motor vehicle, for example, can be kept particularly low.

The sensor element being arranged within the accommodation space or being at least partly covered by the housing element allows in particular the sensor element to be arranged particularly safely in the motor vehicle, in particular in the registration plate illumination device. As a result, the sensor element can be protected particularly reliably against damage, for example. Hence, the service life of the sensor element can be increased to a particular extent. Furthermore, the sensor element can be arranged in the motor vehicle, in particular in the accommodation space, in concealed fashion or in a manner so as to be invisible from the surround. As a result, optics or design of the motor vehicle can for example be designed particularly advantageously.

For example, the wing element can be understood to mean a hatch element, referred to as a hatch in particular. For example, the hatch element is a rear hatch or a door, in particular a side door, of the motor vehicle.

Especially when the wing element is designed as the rear hatch, provision can be made for the person to be situated in the vicinity of the rear hatch when opening the rear hatch or when issuing the voice command. As a result of the registration plate illumination device being arranged in the hatch region of the motor vehicle, in particular on the outer side of the motor vehicle, it is thus possible to capture the acoustic signal particularly well, especially particularly precisely and/or particularly reliably. For example, this can be brought about by virtue of the person being located particularly close to the registration plate illumination device, and hence the sensor element, when opening the rear hatch or issuing the voice command.

In a further configuration, provision is made for the illumination element and the sensor element to be arranged, in particular directly on a mounting element, in particular a common mounting element, that is formed separately from the housing element. Expressed in other words, the illumination element and the sensor element are held on or secured to, in particular directly held on or directly secured to, the mounting element. This means that the illumination element and the sensor element can be installed together on the mounting element, in particular the printed circuit board. As a result, installation space of the registration plate illumination device can be designed particularly advantageously, in particular kept particularly small. For example, the mounting element is designed as a printed circuit board. By preference, the carrier element is arranged, in particular completely arranged, within the accommodation space.

By preference, provision is made for the housing element to have a liquid-tight, in particular watertight design. For example, at least one sealing element is arranged, in particular directly arranged, on the housing element and the sealing element seals or renders sealable the housing element vis-à-vis a surround of the registration plate illumination device. Hence, the liquid-tightness, in particular the watertightness, can be brought about by means of the sealing element. As a result, the registration plate illumination device, in particular housing element, can be kept particularly tight. As a result, the sensor element can be protected particularly well vis-à-vis damage caused by moisture, for example. Hence, the sensor can be arranged or installed in a wet region of the motor vehicle, in particular on the vehicle exterior.

By preference, provision is made for the sensor element to have at least one opening provided to allow sound to enter an interior of the sensor element. Expressed in other words, the acoustic signal is transferable, in particular acoustically transferable, through the opening for capturing the acoustic signal into the interior of the sensor element. This means that the opening is provided to let the sound of the acoustic signal enter the sensor element, in particular the interior.

In so doing, provision is preferably made for the opening to be covered, in particular directly covered, by a membrane, especially in fluid-tight fashion, for example in watertight fashion. Expressed in other words, the opening is at least partially surrounded, in particular completely surrounded, by the membrane in the axial direction of the opening, in particular toward the outside. In yet again other words, the membrane is arranged on the opening, in particular directly on the opening. This means that the opening is at least partly closed, in particular completely closed, by the membrane. As a result, the interior of the sensor element can be protected particularly reliably vis-à-vis the ingress of liquid or moisture.

By preference, the membrane has a sound-transmitting or sound-transmittable embodiment. Therefore, the membrane can be referred to as a sound membrane in particular. This means that the membrane can transmit sound waves, in particular of the acoustic signal, that are incident on a first side to a second side of the membrane that differs from the first side, in particular a second side that is opposite the first side, via the membrane. By preference, the first side is an outer side of the membrane or of the sensor element. By preference, the second side is an inner side of the membrane or of the sensor element. This means that the second side preferably faces the interior and the first side preferably faces away from the interior.

By preference, provision is made for the illumination element to be arranged in a first plane, in particular for the illumination elements to be arranged in the first plane, and for the opening to be arranged in a second plane that differs from the first plane, in particular is arranged at a distance from the first plane. Expressed in other words, the opening is spaced apart from the first plane in particular transversely or perpendicularly to a direction of extent of the first plane. As a result, the acoustic signal can be captured particularly well by means of the sensor element, in particular without errors or in particularly disturbance-resistant fashion.

By way of example, provision is made for the mounting element to be arranged in the first plane and for the respective opening to be arranged in the second plane. In other words, the opening is arranged at a distance from the mounting element, in particular transversely or perpendicularly to the plane of extent of the plane or mounting element. As a result, the acoustic signal can be captured particularly well by means of the sensor element, in particular without errors or in particularly disturbance-resistant fashion.

For example, at least one second sensor element, in particular at least one second acoustic sensor element, that is designed separately from the sensor element is arranged in the accommodation space; the acoustic signal is capturable or captured from the surround of the motor vehicle by means of the second sensor element. For example, this can enable identification of the direction and/or identification of the distance of the acoustic signal, in particular in a particularly reliable and/or particularly precise fashion. As a result, background noise from the surround of the motor vehicle, for example, can be filtered out in a targeted manner. Hence, capture of the acoustic signal can be particularly improved; in particular, the acoustic signal can be captured particularly precisely and/or particularly reliably in the process. Hence, the motor vehicle, in particular the wing element and/or the window, can be operated particularly reliably by the person. This can increase motor vehicle convenience in particular. By preference, the second sensor element is spaced apart from the first sensor element, which is referred to as first sensor element in particular. For example, the second sensor is designed as a microphone.

In a further configuration, provision is made for the sensor elements to be arranged, in particular directly arranged, on the mounting element. Expressed in other words, the sensor elements are secured to or held on, in particular directly secured to or directly held on, the carrier element. This means that the sensor elements can be installed together on the mounting element, in particular the printed circuit board. As a result, installation space of the registration plate illumination device can be designed particularly advantageously, in particular kept particularly small.

For example, provision is made for the sensor elements to be designed together as a sensor element array which is referred to as a microphone array in particular. As a result, directional identification of the acoustic signal, for example, can be conducted particularly precisely. Hence, the capture of the acoustic signal can be improved particularly precisely.

A second aspect of the invention relates to an arrangement of a registration plate illumination device according to the first aspect of the invention in particular, which has a housing and serves to illuminate a registration plate of a motor vehicle, on a component of the motor vehicle. For example, the component is in the form of a bodyshell part of a motor vehicle bodyshell, or the component is formed separately from the bodyshell. For example, the component is in the form of a wing element, in particular a rear hatch. The housing element delimits an accommodation space at least in part, in particular directly, at least one illumination element for illuminating the registration plate being arranged in the accommodation space. Advantages and advantageous configurations of the first aspect of the invention should be considered to be advantages and advantageous configurations of the second aspect of the invention, and vice versa.

By preference, the registration plate illumination device is arranged on an outer side of the motor vehicle, in particular of the bodyshell. Expressed in other words, the registration plate illumination device is situated on the outer side of the motor vehicle or bodyshell. This means that the registration plate illumination device is not arranged in an interior of the motor vehicle referred to as vehicle interior or passenger compartment in particular. Hence the registration plate illumination device is spaced apart from the interior. The registration plate illumination device can be held on the component and/or on the bodyshell, in particular at least indirectly or directly, on the outer side of the bodyshell, in particular by way of the housing element.

The component being formed separately from the bodyshell can be understood to mean that, in particular, the component and the bodyshell are not formed together in one piece. Hence, the component can be an attachment. In particular, the bodyshell and the component are produced separately from one another when these are formed separately from one another. In particular, the component can be formed from a different material to that of the bodyshell.

So as to be able to design the installation space of the motor vehicle particularly advantageously, in particular so as to be able to keep the latter particularly small, the invention provides for at least one sensor element to be arranged in the accommodation space of the registration plate illumination device, by means of which at least one acoustic signal from a surround of the motor vehicle is capturable.

In a further configuration, at least one second sensor element, in particular at least one second acoustic sensor element, is provided, which is formed separately from the sensor element and by means of which the acoustic signal from the surround of the motor vehicle is capturable or captured. By preference, the sensor elements have the same design. For example, the second sensor element is at a distance from the sensor element referred to as first sensor element in particular. This can bring about a detection of direction and/or a detection of distance for the acoustic signal emitted from the surround. As a result, interference noise, for example, can be filtered out, in particular in a targeted manner, whereby the acoustic signal for example can be captured particularly reliably by means of the sensor elements.

The second sensor element can be arranged in the accommodation space, or the second sensor element can be arranged outside of the accommodation space, in particular outside of the registration plate illumination device.

Should the second sensor element be arranged outside of the registration plate illumination device, provision is preferably made for the second sensor element to be arranged in a second registration plate illumination device that is formed separately from the registration plate illumination device, in particular arranged in a second accommodation space of the second registration plate illumination device that differs from the accommodation space. This means that the second registration plate illumination device provided to illuminate the registration plate of the motor vehicle comprises a housing element referred to in particular as a second housing element, for example, the latter at least partly delimiting an accommodation space of the second registration plate illumination device that is in particular referred to as second accommodation space. For example, at least one illumination element of the second registration plate illumination device that is referred to as second illumination element in particular is arranged in the second accommodation space in order to illuminate the registration plate. By preference, provision is made for two respective sensor elements, for example exactly two, of the sensor elements to be arranged in the respective accommodation space of the respective registration plate illumination device.

For example, a cascade can be formed from the two registration plate illumination devices, in particular from the sensor elements of the registration plate illumination devices, whereby spatial noise capture, and spatial noise filtering in particular, can be particularly improved. In this context, the acoustic signal can be captured by means of four sensor elements, whereby the spatial noise capture and/or noise filtering can be particularly improved, especially also in the event of a symmetric arrangement of the sensor elements with respect to one another.

In a further configuration, provision is made for a distance between the noise source emitting the acoustic signal and the motor vehicle, in particular a portion of the motor vehicle, to be ascertainable or ascertained by means of an electronic computing device on the basis of the acoustic signal captured by means of the sensor element. Expressed in other words, a distance between the noise source and the motor vehicle, in particular the portion of the motor vehicle, is ascertainable by means of the electronic computing device. The distance is for example calculated during the ascertainment. The portion of the motor vehicle can be understood to mean a reference point in particular. The reference point can be arranged within the motor vehicle or outside of the motor vehicle. By ascertaining the distance, which can be referred to as detection of distance in particular, the acoustic signal is able to be filtered, for example on the basis of the ascertained distance. Hence it is for example possible to filter out, i.e. not to take account of, background noises, in particular interfering background noises, from further noise sources that differ from the noise source and are particularly far away in particular. This means that interference noises can be particularly minimized. This can particularly increase the reliability with regards to the capture or evaluation of the acoustic signal.

In an alternative to that or in addition, provision is made for a direction of the noise source in relation to the motor vehicle, in particular in relation to the motor vehicle part, to be capturable or captured by means of the electronic computing device. This means that a direction in which the noise source is situated starting from the motor vehicle, in particular from the motor vehicle portion, or a direction in which the said noise source is spaced apart from the motor vehicle, in particular from the motor vehicle portion, is capturable or captured. Ascertaining the direction, which can be referred to as detection of direction in particular, allows the background noises or the interference noises to be filtered out on the basis of the ascertained direction. That is to say, a directional sensitivity while simultaneously filtering out the interference noise can be rendered possible within the scope of signal processing.

In a further configuration, provision is made for the wing element to be held, in particular at least indirectly or directly, on the bodyshell in a manner pivotable between the closed position and at least one open position relative to the bodyshell. Expressed in other words, the wing element is secured, in particular at least indirectly or directly, to the bodyshell, wherein the wing element is pivotable between the closed position and the open position relative to the bodyshell about a pivot axis. For example, an opening, in particular an opening delimited by the bodyshell and for example referred to as a hatch opening, is closed, in particular completely closed, by the wing element in the closed position. For example, the opening is cleared at least in part, in particular in full, by the wing element in the open position. For example, the opening is an access to an interior or a loading space of the motor vehicle.

By preference, provision is made for at least one coupling device, in particular an electrical and/or mechanical coupling device, that is couplable or coupled, in particular in electrical and/or mechanical fashion, to the wing element, by means of which coupling device the wing element is pivotable or pivoted between the closed position and the open position on the basis of the acoustic signal captured by means of the sensor element and/or second sensor element. Expressed in other words, the wing element is pivotable from the closed position into the open position and/or from the open position into the closed position, in particular about the pivot axis, on the basis of the acoustic signal captured by means of at least one of the sensor elements. This means that the wing element, in particular the rear hatch, can be opened and/or closed under voice control. As a result, the wing element can be opened with particularly little outlay, and the motor vehicle convenience can be particularly increased thereby in particular. For example, the wing element is pivotable between the closed position and the open position by means of the coupling device in a manner dependent on the parameter captured by means of the sensor element and/or second sensor element.

For example, for the purpose of bringing about the wing element pivoting, provision is made for at least one control signal to be transmittable or transmitted to the coupling device by the electronic computing device on the basis of the acoustic signal captured by means of at least one of the sensor elements or on the basis of the respective parameter captured by means of at least one of the sensor elements. Hence the wing element can be opened and/or closed by means of the coupling device on the basis of the control signal transmitted from the electronic computing device to the coupling device. The coupling device is preferably arranged outside of the housing element. The electronic computing device can be arranged within the housing element or outside of the housing element.

By preference, provision is made for the acoustic signal captured by means of at least one of the sensor elements to be compared with at least one reference signal by means of the electronic computing device. In this case, the wing element is for example pivoted between the closed position and the open position by means of the coupling device should a criterion, in particular a predefined criterion, be satisfied, for example if the captured acoustic signal corresponds to the reference signal. The reference signal can be understood to be a reference voice signal in particular, i.e. a reference voice message or a reference voice command. By preference, the wing element is not pivoted between the closed position and the open position if the criterion, in particular the predefined criterion, is not satisfied, for example if the captured acoustic signal does not correspond to the reference signal, i.e. if the captured acoustic signal for example differs from the reference signal.

By preference, provision is made for the comparison of the captured acoustic signal with the reference signal to be carried out should the ascertained distance have a first distance value or correspond to the first distance value. By preference, the comparison of the captured acoustic signal with the reference signal is omitted should the ascertained distance have a second distance value that differs from the first distance value, in particular is greater than the first distance value, or correspond to the second distance value.

By preference, provision is made for the comparison of the captured acoustic signal with the reference signal to be carried out should the ascertained direction have a first direction value or correspond to the first direction value. By preference, the comparison of the captured acoustic signal with the reference signal is omitted should the ascertained direction have a second direction value that differs from the first direction value or correspond to the second direction value.

By way of example, a sensor device formed separately from the registration plate illumination device in particular is provided, an object situated in the surround and/or in the motor vehicle, in particular an object that differs from the noise source, being capturable by means of the sensor device. For example, the object is a key, referred to as vehicle key in particular, for the motor vehicle or of the motor vehicle. In particular, a spacing between the object and the motor vehicle, in particular the motor vehicle part, is capturable or ascertainable by means of the sensor device.

By preference, provision is made for the wing element to be pivoted should the object be spaced apart from the motor vehicle at a first spacing value or be situated within the motor vehicle. By preference, pivoting of the wing element is omitted should the object be spaced apart from the motor vehicle at a second spacing value that differs from the first spacing value, with the second spacing value preferably being greater than the first spacing value. The respective spacing value can in particular be understood to mean a respective spacing value captured by means of the sensor device. Hence the wing element can be pivoted on the basis of the captured acoustic signal only if the sensor device should recognize that the object, in particular the key, is situated at least in the vicinity of the motor vehicle.

By preference, provision is made for the comparison of the captured acoustic signal with the reference signal to be carried out depending on the object captured by means of the sensor device. For example, provision is made here for the comparison of the captured acoustic signal with the reference signal to be carried out should a difference between the ascertained distance and the ascertained spacing be smaller than a predefined threshold value. By preference, the comparison of the captured acoustic signal with the reference signal is omitted should the distance between the ascertained distance and the ascertained spacing be greater than the predefined threshold value. As a result, the background noises referred to as interference noises in particular can be filtered out particularly well.

In an alternative to that or in addition, provision is for example made for an object direction to be capturable or ascertainable by means of the sensor device, the object being situated in the said object direction in relation to the motor vehicle, in particular to the motor vehicle portion. In this case, provision is preferably made for the comparison of the captured acoustic signal with the reference signal to be carried out should a difference between the ascertained direction and the ascertained object direction be smaller than a predefined threshold value that is referred to as second threshold value in particular. By preference, the comparison of the captured acoustic signal with the reference signal is omitted should the difference between the ascertained direction and the ascertained object direction be greater than the predefined threshold value. As a result, the background noises referred to as interference noises in particular can be filtered out particularly well.

A third aspect of the invention relates to a method for operating a motor vehicle comprising at least one registration plate illumination device, in particular according to the first aspect of the invention. Advantages and advantageous configurations of the first and second aspect of the invention should be considered to be advantages and advantageous configurations of the third aspect of the invention, and vice versa.

In the method, provision is made for at least one acoustic signal from a surround of the motor vehicle to be captured by means of at least one sensor element arranged in an accommodation space which is at least partly delimited, in particular completely delimited, by a housing element of the registration plate illumination device and in which at least one illumination element of the registration plate illumination device for illuminating a registration plate of the motor vehicle is arranged. In particular, the method can be referred to as a method for operating the registration plate illumination device or as a method for capturing an acoustic signal for a motor vehicle. For example, the registration plate is illuminated by means of the illumination element.

A fourth aspect relates to a method for operating an arrangement according to the second aspect of the invention. Advantages and advantageous configurations of the first aspect of the invention and of the second aspect of the invention and of the third aspect of the invention should be considered to be advantages and advantageous configurations of the fourth aspect, and vice versa.

Further features of the invention arise from the claims, the figures and the description of the figures. The features and feature combinations specified above in the description and the features and feature combinations specified in the description of the figures below and/or only shown in the figures can be used not only in the respective specified combination but also in other combinations or on their own.

The invention will now be explained in detail on the basis of a preferred exemplary embodiment and with reference to the drawings.

### BRIEF DESCRIPTION OF THE DRAWINGS

FIG. 1 is a schematic partial sectional view of a motor vehicle which comprises a registration plate illumination device according to an embodiment of the invention and which is operable by means of a method according to an embodiment of the invention.

FIG. 2 is a schematic and perspective partial view of a registration plate illumination device according to an embodiment of the invention.

FIG. 3 is a schematic method flowchart for a method according to an embodiment of the invention.

FIG. 4 is a schematic partial sectional view of a registration plate illumination device according to an embodiment of the invention; and

FIG. 5 is a schematic partial sectional view of a registration plate illumination device according to the invention as per a further embodiment.

In the figures, the same or functionally equivalent elements are provided with the same reference signs.

### DETAILED DESCRIPTION OF THE DRAWINGS

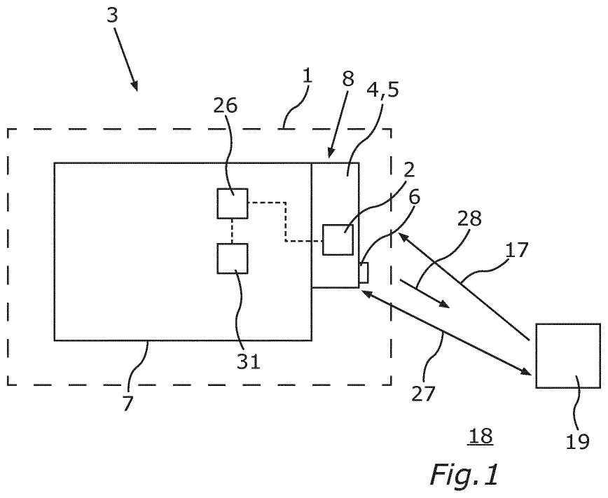

FIG. 1 shows a motor vehicle 1, which comprises a registration plate illumination device 2, in a schematic partial sectional view. Hence, FIG. 1 shows an arrangement 3 of the registration plate illumination device 2 on a component 4 of the motor vehicle 1. In the exemplary embodiment, the component 4 is formed as a wing element 5, in particular as a rear hatch. The motor vehicle 1 comprises a registration plate 6 referred to as a license plate in particular, which for example is arranged or held on the wing element 5, in particular the rear hatch. The registration plate illumination device 2 is provided for the illumination of the registration plate 6.

By preference, the component 4 is formed separately from a bodyshell 7 of the motor vehicle 1. In particular, the component 4 is held, in particular directly held, on the bodyshell 7. Hence, the registration plate illumination device 2 is held on the bodyshell 7 by way of the component 4. In particular, the registration plate illumination device 2 is arranged on an outer side 8 of the motor vehicle 1, in particular of the bodyshell 7.

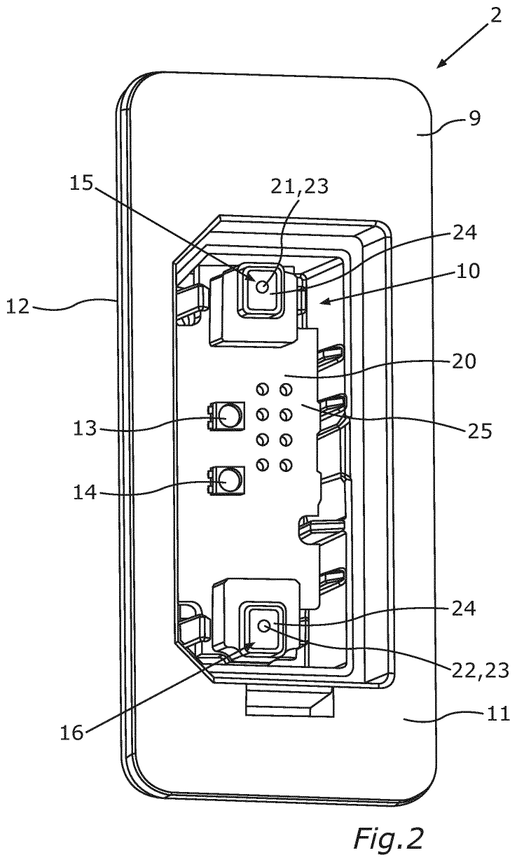

FIG. 2 shows the registration plate illumination device 2 in a schematic partial view. The registration plate illumination device 2 comprises at least one housing element 9, which at least partly delimits, in particular completely delimits, an accommodation space 10. The housing element 9 can be formed in one or more pieces. For example, the housing element 9 comprises a housing part 11. For example, a sealing element 12, formed separately from the housing part 11 in particular, is arranged on the housing part 11. For example, the sealing element 12 rests, in particular rests directly, on the bodyshell 7. Hence, the housing element 9, in particular the housing part 11, is sealed with respect to the bodyshell 7, for example by way of the sealing element 12.

At least one illumination element 13 provided for illuminating the registration plate 6 is arranged in the accommodation space 10. In the exemplary embodiment shown in FIG. 2, two illumination elements 13, 14, in particular exactly two, for illuminating the registration plate 6 are arranged in the accommodation space 10. By preference, the illumination elements 13, 14 are spaced apart from one another. By way of example, the respective illumination element 13, 14 is embodied as a respective LED.

In order to be able to design an installation space of the motor vehicle 1 particularly advantageously, in particular in order to be able to keep the latter particularly small, provision is made for at least one sensor element 15, 16, in particular at least one acoustic sensor element, to be arranged in the accommodation space 10, at least one acoustic signal 17 from a surround 18 of the motor vehicle being capturable or captured by means of the sensor element. In the exemplary embodiment shown in FIG. 2, two of the sensor elements 15, 16, in particular exactly two, are arranged in the accommodation space 10, wherein the acoustic signal 17 is capturable or captured by the sensor elements 15, 16. The respective sensor element 15, 16 is for example in the form of a respective microphone. In this case, the respective microphone is preferably designed as a respective digital microphone. As a result, interfering influences, in particular vis-à-vis a respective analog microphone, can be kept particularly low.

For example, the acoustic signal 17 is emitted by a noise source 19 situated in the surround 18 of the motor vehicle 1. For example, the noise source 19 is a person.

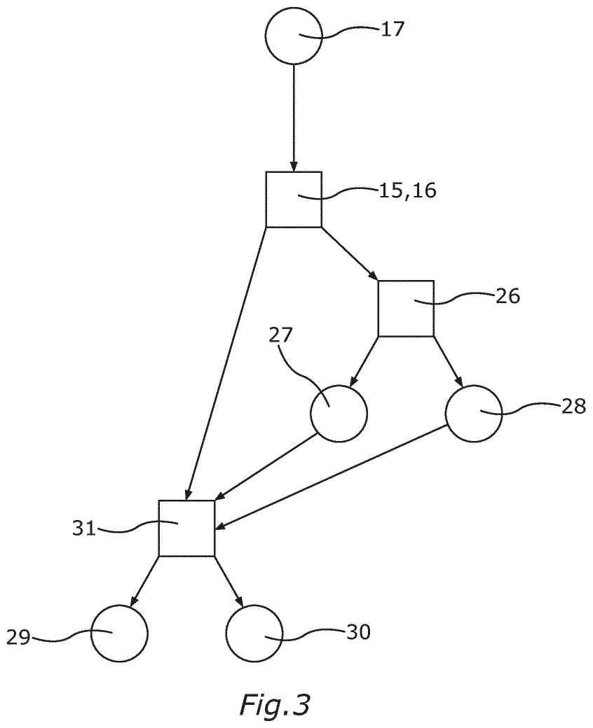

FIG. 3 shows a schematic method flowchart of a method for operating the motor vehicle 1, in particular for operating the registration plate illumination device 2. In the method, the at least one acoustic signal 17 from the surround 18 of the motor vehicle 1 is captured by means of the respective sensor element 15, 16 arranged in the accommodation space 10.

By preference, provision is made for the respective sensor element 15, 16 to be formed on a mounting element 20, in particular a joint mounting element, which is in the form of a printed circuit board for example and which is formed separately from the housing element 9. For example, the respective sensor element 15, 16 is mechanically and/or electrically connected to the mounting element 20. By preference, provision is made for the respective illumination element 13, 14 and the respective sensor element 15, 16 to be arranged on the mounting element 20.

In a further configuration, provision is made for the respective sensor element 15, 16 to have at least one respective opening 21, 22 provided for the entry of sound into a respective interior of the respective sensor element 15, 16. This means that a first of the sensor elements 15 has a first of the openings 21 and that the second sensor element 16 has the second opening 22. The respective opening 21, 22 is preferably covered in each case by a respective membrane 23, especially in fluid-tight fashion.

For example, the registration plate illumination device 2 comprises at least two passage openings, in particular exactly two, which are each assigned to a respective one of the sensor elements 15, 16, in particular of the respective opening 21, 22 or membrane 23. A first of the passage openings is assigned to the first sensor element 15. A second of the passage openings is assigned to the second sensor element 16. By way of the respective passage opening, the respective sensor element 15, 16 assigned to the respective passage opening, in particular the respective opening 21, 22 or the respective membrane 23, is connected or connectable in sound-transmitting and/or sound-passing fashion to the surround 18. Hence, the respective passage opening is provided for the entry of sound, in particular the acoustic signal 17, into the respective interior of the respective sensor element 15, 16.

By way of example, the respective passage opening has a nonuniform or irregular shape, in particular in its axial direction, for example in the radial direction and/or circumferential direction. Thus, the respective passage opening can have irregular radii, for example, in particular along its axial direction. This means that the respective passage opening can for example have the shape of a trumpet. As a result, the acoustic signal 17 can be captured or received particularly well by means of the respective sensor element 15, 16.

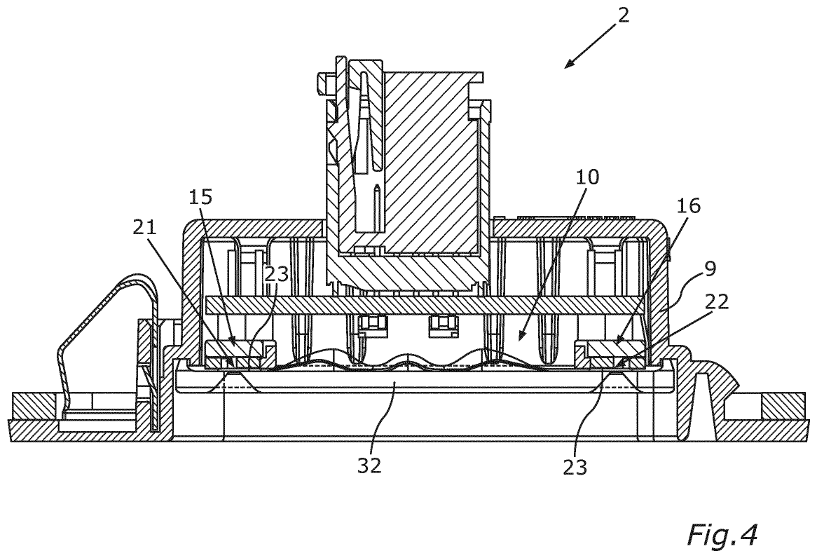

FIG. 4 shows the registration plate illumination device 2 in a schematic partial sectional view. For example, the registration plate illumination device 2 comprises at least one lens 32, in particular at least one transparent lens.

For example, the respective opening 21, 22 is arranged in the lens 32. Hence, the lens 32 might contain the openings 21, 22. In this case, the respective opening 21, 22 can be understood to mean a respective hole in the lens 32 in particular.

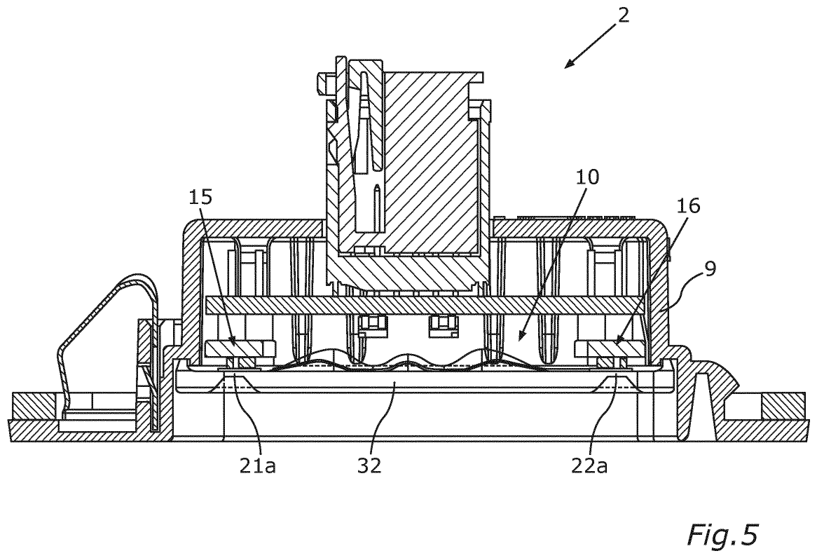

FIG. 5 shows the registration plate illumination device 2 in a schematic partial sectional view according to a further embodiment in which the registration plate illumination device 2, in particular the lens 32, does not contain the respective opening 21, 22, i.e. is free from the respective opening 21, 22. For example, the lens 32 has a particularly thin embodiment in the respective portions 21a, 22a vis-à-vis the further portions of the lens 32 adjoining the respective portion 21a, 22a at least in indirect or direct fashion in particular. This means that the lens 32 can have a particularly thin-walled embodiment locally. Hence, a wall thickness of the lens in the respective portion 21a, 22a of the lens 32 is for example thinner than in the further portions of the lens 32. As a result, it is possible to manage without the membrane 23 and in particular without the openings 21, 22. Hence, the respective portion 21a, 22a of the lens 32 can be provided for the entry of sound into the respective interior of the respective sensor element 15, 16. This means that the sound can be transmitted into the interior of the respective sensor element 15, 16 via the respective portion 21a, 22a. This means that, for example, the opening 21 can be “replaced” by the portion 21a and the opening 22 can be “replaced” by the portion 22a. The respective sensor element 15, 16 thus can “hear” via the respective portion 21a, 22a or via the particularly thin-walled lens 32. For example, a wall thickness of the lens 32 in the respective portion 21a, 22a is 0.5 millimeters. For example, a wall thickness of the lens 32 is 2 mm in the further portions.

In a further configuration, provision is made for the respective illumination element 13, 14, in particular the mounting element 20, to be arranged in a first plane 24 and for the respective opening 21, 22 to be arranged in a second plane 25 that differs from the first plane 24 and in particular is spaced apart from the first plane 24. By preference, the mounting element 20 extends in the first plane 24.

For example, the motor vehicle 1 comprises a registration plate bracket, by means of which the registration plate 6 is held, in particular directly, on the component 4 and on the rear hatch in particular. By preference, the registration plate illumination device 2, in particular the respective illumination element 13, 14 and/or the respective sensor element 15, 16, is arranged above the registration plate bracket and above the registration plate 6 in particular in the vertical direction of the motor vehicle 1. For example, the registration plate illumination device 2, in particular the housing element 9, extends transversely or perpendicularly to the registration plate bracket and to the registration plate 6 in particular.

By way of example, the motor vehicle 1 comprises at least one second registration plate illumination device that is formed separately from the registration plate illumination device 2, in particular spaced apart from the registration plate illumination device 2, for example in the transverse vehicle direction of the motor vehicle 1. By preference, the second registration plate illumination device comprises at least two sensor elements, in particular exactly two, by means of which the acoustic signal 17 from the surround 18 of the motor vehicle 1 is capturable or rendered capturable. This means that for example in each case two of the sensor elements can be integrated in the respective registration plate illumination device in order in particular to enable a cascade of four sensor elements, especially in the rear region of the motor vehicle 1.

In a further configuration, provision is made for at least one electronic computing device 26, by means of which a distance 27 between the noise source 19 emitting the acoustic signal 17 and the motor vehicle 1 is ascertainable or ascertained on the basis of the acoustic signal 17 captured by means of the respective sensor element 15, 16. In an alternative to that or in addition, provision is made for a direction 28, in which the noise source 19 is situated in relation to the motor vehicle 1, to be ascertainable or ascertained by means of the electronic computing device 26 on the basis of the acoustic signal 17 captured by means of the respective sensor element 15, 16.

By preference, provision is made for the wing element 5, in particular the rear hatch, to be held on the bodyshell 7 in a manner pivotable between a closed position 29 and at least one open position 30 relative to the bodyshell 7. In a further configuration, provision is made for at least one coupling device 31 which is couplable or coupled to the wing element 5, in particular the rear hatch, and by means of which the wing element 5, in particular the rear hatch, is pivotable or pivoted between the closed position 29 and the open position 30 on the basis of the acoustic signal 17 captured by the respective sensor element 15, 16, in particular on the basis of the ascertained distance 27 and/or on the basis of the ascertained direction 28.

### LIST OF REFERENCE SIGNS

1 Motor vehicle
2 Registration plate illumination device
3 Arrangement
4 Component
5 Wing element
6 Registration plate
7 Bodyshell
8 Outer side
9 Housing element
10 Accommodation space
11 Housing part
12 Sealing element
13 First illumination element
14 Second illumination element
15 First sensor element
16 Second sensor element
17 Acoustic signal
18 Surround
19 Noise source
20 Mounting element
21 First opening
21a Portion
22 Second opening
22a Portion
23 Membrane
24 First plane
25 Second plane
26 Electronic computing device
27 Distance
28 Direction
29 Closed position
30 Open position
31 Coupling device
32 Lens

1.-10. (Canceled)

11. A vehicle registration plate illumination device for illuminating a vehicle registration plate of a motor vehicle, comprising:
a housing element which at least partly delimits an accommodation space;
at least one illumination element arranged in the accommodation space and serving to illuminate the registration plate; and
at least one sensor element which is arranged in the accommodation space and by which at least one acoustic signal from a surround of the vehicle is capturable.

12. The vehicle registration plate illumination device according to claim 11, wherein
the illumination element and the sensor element are arranged on a mounting element that is formed separately from the housing element.

13. The vehicle registration plate illumination device according to claim 11, wherein
the sensor element has at least one opening provided to allow sound to enter an interior of the sensor element.

14. The vehicle registration plate illumination device according to claim 13, wherein
the at least one opening is covered by a membrane.

15. The vehicle registration plate illumination device according to claim 13, wherein
the illumination element is arranged in a first plane, and
the at least one opening is arranged in a second plane that differs from the first plane.

16. An arrangement, comprising:
a component of a motor vehicle;
a registration plate illumination device, which comprises a housing element and serves to illuminate a registration plate of the motor vehicle, on the component of the motor vehicle, wherein the housing element at least partly delimits an accommodation space;
at least one illumination element for illuminating the registration plate arranged in the accommodation space of the registration plate illumination device; and
at least one sensor element arranged in the accommodation space of the registration plate illumination device by which at least one acoustic signal from a surround of the motor vehicle is capturable.

17. The arrangement according to claim 16, further comprising:
at least one second sensor element, which is formed separately from the sensor element, and by which the acoustic signal from the surround of the motor vehicle is capturable.

18. The arrangement according to claim 17, further comprising:
at least one electronic calculation device, by which:
(i) a distance between a noise source emitting the acoustic signal and the motor vehicle is ascertainable, and/or
(ii) a direction in which the noise source is located relative to the motor vehicle is ascertainable,
in each case based on the acoustic signal captured via the respective sensor elements.

19. The arrangement according to claim 16, further comprising:
a wing element held on a bodyshell of the motor vehicle in a manner pivotable between a closed position and at least one open position relative to the bodyshell, and
a coupling device that is couplable or coupled to the wing element and by which the wing element is pivotable between the closed position and the open position based on the acoustic signal captured via the sensor element.

20. A method for operating a vehicle having a registration plate illumination device, the method comprising:
providing at least one sensor element arranged in an accommodation space which is at least partly delimited by a housing element of the registration plate illumination device and in which at least one illumination element of the registration plate illumination device for illuminating a registration plate of the motor vehicle is arranged; and
capturing at least one acoustic signal from a surround of the motor vehicle via the at least one sensor element arranged in the accommodation space.
